(19) United States
(12) Patent Application Publication
(10) Pub. No.: US 2022/0309943 A1
(43) Pub. Date: Sep. 29, 2022

(54) PROACTIVE TRAINING VIA VIRTUAL REALITY SIMULATION

(71) Applicant: KYNDRYL, INC., NEW YORK, NY (US)

(72) Inventors: Tory Mitchell Liesenfelt, Boulder, CO (US); Shikhar Kwatra, San Jose, CA (US); Vinod A. Valecha, Pune (IN); Sarbajit K. Rakshit, Kolkata (IN)

(21) Appl. No.: 17/209,532

(22) Filed: Mar. 23, 2021

(51) Int. Cl. G09B 9/00; G06N 5/04

(52) U.S. Cl. CPC G09B 9/00; G06N 5/04

(57) ABSTRACT

A processor may receive data associated with a user. The processor may determine, using an artificial intelligence model, a contextual situation the user is likely to encounter. The processor may identify, using the artificial intelligence model, a task that the user is likely to perform in the contextual situation. The processor may determine, using the artificial intelligence model, a criticality of the task the user is likely to perform in the contextual situation. The processor may generate a simulation of the task in a virtual reality simulation. The processor may prompt the user to utilize the task simulation to learn how to perform the task.

### BACKGROUND

The present disclosure relates generally to the field of virtual reality simulations, and more specifically to simulating tasks a user is likely to encounter in a contextual situation.

Virtual reality environments may include three-dimensional, computer-generated environments that can be explored by a user and interacted with.

### SUMMARY

Embodiments of the present disclosure include a method, computer program product, and system for simulating tasks a user is likely to encounter in a contextual situation.

A processor may receive data associated with a user. The processor may determine, using an artificial intelligence model, a contextual situation the user is likely to encounter. The processor may identify, using the artificial intelligence model, a task that the user is likely to perform in the contextual situation. The processor may determine, using the artificial intelligence model, a criticality of the task the user is likely to perform in the contextual situation. The processor may generate a simulation of the task in a virtual reality simulation. The processor may prompt the user to utilize the task simulation to learn how to perform the task.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a block diagram of an exemplary system for simulating tasks likely to be encountered in a contextual situation, in accordance with aspects of the present disclosure.

FIG. 2 is a flowchart of an exemplary method for simulating tasks likely to be encountered in a contextual situation, in accordance with aspects of the present disclosure.

FIG. 3A illustrates a cloud computing environment, in accordance with aspects of the present disclosure.

FIG. 3B illustrates abstraction model layers, in accordance with aspects of the present disclosure.

FIG. 4 illustrates a high-level block diagram of an example computer system that may be used in implementing one or more of the methods, tools, and modules, and any related functions, described herein, in accordance with aspects of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of virtual reality simulations, and more specifically to simulating tasks a user is likely to encounter in a contextual situation. While the present disclosure is not necessarily limited to such applications, various aspects of the disclosure may be appreciated through a discussion of various examples using this context.

In some embodiments, a processor may receive user data associated with a user. In some embodiments, the processor may determine, using an artificial intelligence model, a contextual situation the user is likely to encounter in the future from the user data associated with the user. For example, a user may opt-in to share information from her email, calendar, social media accounts, or IoT devices to the processor. The user data may be input into an artificial intelligence model that can identify from the user data a contextual situation the user is likely to encounter in the future. For example, the AI model may determine that a user is interested in attending a work-related conference at a new ski resort in the mountains. The user may have received an email about the conference and inquired about the presenters at the conference and expense reimbursement for the conference. The user may have signed up for the conference, scheduled it on her calendar, and booked air travel. In some embodiments, the user data may be obtained from a calendar of the user, social media feeds, information communicated in emails, a history of past behavior of the user (e.g., the user always attends a conference in the winter), etc.

In some embodiments, the processor may identify, using the artificial intelligence model, a task that the user is likely to perform in the contextual situation. Continuing the previous example, the AI model may identify that the user may go skiing while attending the conference. In some embodiments, the AI model have been trained using data about the contextual situation and tasks that the user may likely perform in the contextual situation. For example, the data may include data from the ski resort website, visitor comments on online reviews of the ski resort, pictures from past conferences from the conference organizer's website, IoT sensors (e.g., detecting the weather conditions at the resort), etc. From the data about the contextual situation and the data associated with the user, the AI model may be able to identify situations that the user is likely to encounter during the conference and tasks that the user may have to perform while attending the conference. For example, the AI model may identify that the user may go downhill skiing or snowboarding at the ski resort based on activities described on the ski resort website. Based on images from previous years' conferences, the AI model may also identify that at past conferences an archery tournament was arranged and that the user may possibly perform in the archery tournament. From online reviews of the ski resort describing the road to the ski resort as narrow and winding, the AI model may identify that driving in wintry weather on narrow roads is a task the user may perform when going to the conference. From the emails of the user, the processor may identify that the user is to make a presentation at the conference.

In some embodiments, the processor may determine, using the artificial intelligence model, a criticality of the task the user is likely to perform in the contextual situation. In some embodiments, the AI model may identify tasks the user may encounter during the contextual situation and problems the user may have with the task (e.g., regarding knowledge of the steps required to perform the task, the skills required to perform the task, logistical issues, etc.). For example, tasks the user may perform that the user may have difficulty with include: renting a vehicle (e.g., the user may not know the pickup location for the car rental), reading a map to determine the route to the location (e.g., if there is no access to GPS directions in the remote location), using a mobile device to place a food order at a service area along the highway, etc.

In some embodiments, the processor may assess how critical it is for the user to learn the task before encountering the task in the contextual situation. In some embodiments the user data received by the processor may be associated with possible prior experiences of the user with the contextual scenario or with performing the task. In some embodiments, the user data may include data associated with a prior experience of the user. In some embodiments, the user data may be associated with the skill of the user in performing the task. For example, from prior experiences of the user traveling to cities that are known for their ski resorts, the AI model may assess that the user has likely previously gone to ski resorts and gone skiing or snowboarding. From comments the user posted on social media regarding snowboarding, pictures on social media showing the user snowboarding, and a lack of pictures on social media showing the user skiing, the AI model may assess that the user likely knows how to snowboard but may not know how to ski (or have a low skill level). As an example, the task of skiing may be identified as critical because of the predicted low skill of the user skiing and the predicted likelihood that the user may want to ski at the ski resort.

For example, based on an email from the user's supervisor sharing that the supervisor is an avid archer and is looking forward to the archery tournament, the archery tournament may also be identified as a critical task to be performed in the contextual situation. Additionally, from forecasted icy and snowy weather on the day that the user is planning to drive to the ski resort, the AI model may determine that driving in wintry weather in the mountains is a task that the user is very likely to perform. Based on safety issues and the dependence of other tasks (e.g., presenting at the conference, meeting with colleagues, participating in the archery tournament, going skiing, etc.) on a safe arrival to the resort, the task of driving in wintry weather may be identified as critical. Finally, based on email communications between the user and conference organizers, the processor may determine that the user will have to utilize unfamiliar technology (e.g., hardware and applications) when making the presentation at the conference.

In some embodiments, the criticality assessment may be based on a predicted skill of the user in performing the task (e.g., prior experiences skiing). In some embodiments, the criticality assessment may be based on the difficulty level of the task (e.g., driving on narrow roads during wintry weather), the likelihood that the task will be encountered (e.g., archery tournament), the effect of the performance of the task on other tasks to be performed (e.g., arrival to the resort), etc. In some embodiments, the criticality assessment may be based on a combination of the predicted skill of the user and a criticality assessment of the task. In some embodiments, the task may be identified as critical based on background data about the contextual situation or task (e.g., activities offered at the resort), timing or context surrounding the contextual situation (e.g., the weather on the dates traveling), or the availability of resources for the user (e.g., mobile internet connection, GPS, or other travelers who can assist in navigating the route to the ski resort).

In some embodiments, the processor may generate a simulation of the task in a virtual reality simulation. In some embodiments, the processor may prompt the user to utilize the task simulation to learn how to perform the task. In some embodiments, a virtual reality (“VR”) simulation may be created of the contextual situation, or a portion of the contextual situation, in which the user has to perform tasks that were assessed as critical. For example, the VR simulation may involve driving under wintry conditions on a narrow, mountainous road. The VR simulation may include various obstacles the user may encounter while driving on the road (e.g., low traction, invisible ice patches, slowed vehicles in front of the user, wide trucks on the lane with opposing traffic, low visibility, snow splashes from nearby vehicles, etc.). In some embodiments, the processor may prompt the user to utilize the driving simulation. In some embodiments, the processor may inform the user of the expected weather and that the driving conditions may require that the user learn improved driving skills that focus on driving in wintry conditions.

In some embodiments, the VR simulation of the task may include a simulation of each successive step that the user may need to perform. For example, the user may need to learn how to use unfamiliar software and hardware for making a presentation during the conference. The VR simulation may include: how to send the presentation to the conference hardware, how to find the presentation on the new hardware, how to open the presentation using the new application, how to go flip between slides in the presentation, how to make sure the display to the audience is working properly, how to make sure the microphone is work properly, where the user should stand to make sure she is visible to the camera recording the presentation, etc.

In some embodiments, that processor may assess that a task is critical by determining a criticality score for the task and determining that the criticality score exceeds a criticality threshold. For example, the task of skiing may be assigned a criticality score of 70 based on the conference taking place at a ski resort, the user having previous visits to towns that are known for ski resorts, the user's interest in snowboarding, and a lack of images showing the user skiing. If the criticality threshold is 50, the task of skiing may be assessed to be critical and included in the VR simulation.

In some embodiments, that processor may assess that a task is critical by predicting the prior experience of the user with the task. The processor may assign a skill score to the prior experience of the user and determine that the skill score is below a skill threshold. For example, based on the file type used for the draft presentation that the user emailed the conference organizer, the processor may predict that the user does not have prior experience with the applications and hardware used to make presentations at the conference. Based on the difference between the application and hardware at the conference and the application the user utilized to draft her presentation (and how less commonly utilized the application and hardware at the conference are), the processor may assign a skill score of three out of ten to the user for using that application and hardware. If the skill threshold is five, a score of three may result in an assessment that the task (e.g., learning skills associated with the task) is critical.

In some embodiments, the skill of the user performing the task may be assessed during the VR simulation. In some embodiments, based on this assessment, the priority or criticality of the user learning this task may be updated. In some embodiments, the system may dynamically update the VR simulation (e.g., retrieve different instructions for different skill levels, generate different goals depending on the skill level, etc.), the prompts, and the timeframe assessment based on how the user performs the task in the VR simulation.

In some embodiments, the processor may determine a number of times the user experiences the task simulation in the virtual reality simulation based on the skill score of the user or the criticality score for the task. For example, if the user has a low skill score for a particular task, the VR simulation may include repeated opportunities for the user to perform the task simulation. For example, the VR simulation may include five repetitions of the user skiing downhill. In some embodiments, the number of times a user experiences the task simulation may increase the higher the criticality score is for the task. In some embodiments, the number of times a user experiences the task simulation may be based on a combination of the skill score of the user for the task and the criticality score for the task.

In some embodiments, the processor may determine a state level of the user while the user is utilizing the task simulation. In some embodiments, the processor may determine a number of times the user experiences the task simulation in the virtual reality simulation based on the state level. In some embodiments, the state level may reflect a characteristic of the user such as an emotion, stress, strain, etc. For example, the user may perform the task simulation on a VR device that has sensors that detect physiological characteristics of the user such as heartrate or perspiration. In some embodiments, the processor may utilize the sensor data to determine a state level of the user. For example, as the user is simulating the steps of giving a presentation at the conference, the processor may detect the state level of the user in performing different steps of the giving a presentation. Based on the state level, the processor may determine to include more simulations of steps that the user is having difficulty with (e.g., steps during which the user experiences heightened physiological characteristics associated with stress).

In some embodiments, prompting the user to utilize the task simulation may include an assessment of the timeframe for the user to perform the task in the contextual situation. For example, if there is less time until the scheduled conference, the user may be prompted more frequently or with greater urgency (e.g., more intensely, more persuasively, with greater importance, etc.) to utilize the VR simulation to learn the task. In some embodiments, the type of prompt (e.g., more intense/persuasive) and/or the frequency of the prompt may depend on a combination of how soon the user is expected to perform the task in the contextual situation and how much time it may take for the user to learn the task (e.g., based on the skill score of the user, the performance of the user in prior simulations of the task, or historical data available to the AI model related to the task).

In some embodiments, the processor may identify a timeframe for the user to perform a first task. In some embodiments, the processor may identify a second timeframe for the user to perform a second task. In some embodiments, the processor may compare the first timeframe to the second timeframe. In some embodiments, the processor may prioritize a generation of a first task simulation in the virtual reality simulation. In some embodiments, the processor may prioritize generating a first task simulation in the argument reality simulation over generating a second task simulation. In some embodiments, the processor may make the prioritization based on a comparison of a criticality score for the first task to a criticality score for the second task. In some embodiments, the processor may make the prioritization based on a comparison of a skill score for the first task to a skill score for the second task.

For example, the processor may prioritize generating a simulation of driving in wintry weather over generating a simulation of the archery tournament because the user may have to drive in wintry weather on the first day of the conference while the archery tournament is during the final days of the conference. The processor may also prioritize generating a simulation of driving in wintry weather because driving in wintry weather may have a higher criticality score than the archery tournament. Additionally, the processor may prioritize generating a simulation of the archery tournament over generating a simulation of downhill skiing base on a prediction that the user is likely less skilled performing archery than downhill skiing (e.g., based on skill scores).

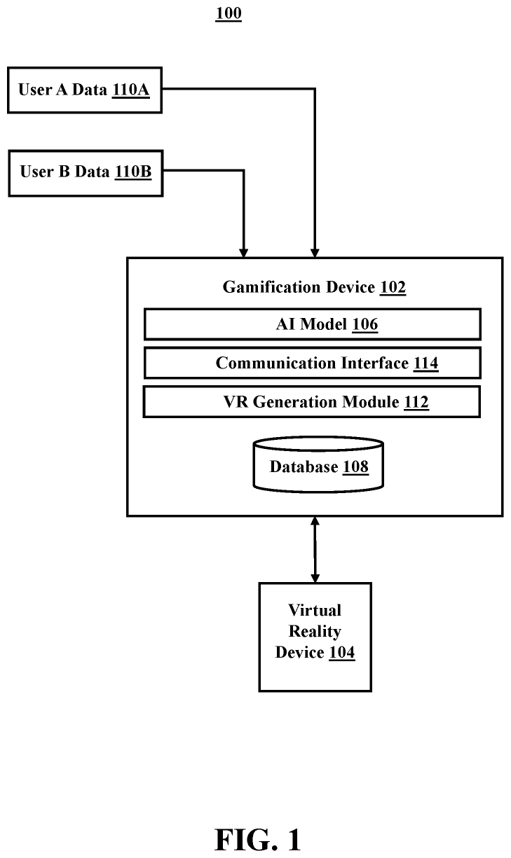

Referring now to FIG. 1, a block diagram of a system 100 for simulating tasks likely to be encountered in a contextual situation is illustrated. System 100 includes a gamification device 102 and a virtual reality device 104. The gamification device 102 and the virtual reality device 104 are configured to be in communication with each other. In some embodiments, the gamification device 102 and the virtual reality device 104 may be any devices that contain a processor configured to perform one or more of the functions or steps described in this disclosure. Gamification Device 102 includes an AI model 106 and a database 108 for storing data associated with the AI model 106 including user A data 110A, user B data 110B, data associated with the contextual situation, data associated with the tasks likely to be performed in the contextual situation, data regarding the prior experience or skill of user A and/or user B (after user A and/or user B use the gamification device) performing a task, data regarding a criticality assessment of the task, data regarding simulation of the task, data associated with measurement of a user state during VR simulations (discussed above).

In some embodiments, a processor of the system gamification device 102 receives data associated with user A, user A data 110A. The gamification device 102 determines a contextual situation that user A is likely to encounter in the future using AI model 106 using user A data 110A. The gamification device 102 also uses AI model 106 to identify a task that the user is likely to perform in the contextual situation based on the user A data 110A and the training the AI model 106 received using data associated with contextual situations and tasks stored in database 108. The gamification device 102 determines a criticality of the task the user is likely to perform. In some embodiments, the criticality is determined based on attributes of the task ascertained by the AI model, and in some embodiments, the criticality is determined based on the prior experience of the user (determined by from user A data 110A) with the task. The gamification device 102 generates a simulation of the task using VR generation module 112. The task is simulated in a virtual reality simulation on virtual reality device 104. The gamification device 102 utilizes communication interface 114 to communicate with a user (e.g., by pushing a notification to the user's phone, tablet, computer (not illustrated)) about the task the user is likely to perform in a contextual situation the user is likely to encounter in the future. The communication may also describe the difficulty of the task and the skills needed to perform the task. The gamification device 102 may prompt the user to utilize the task simulation on the virtual reality device 104 to learn how to perform the task.

In some embodiments, the gamification device 102 determines the criticality of the task by determining a criticality score for the task and determining that the criticality score exceeds a criticality threshold. In some embodiments, the gamification device 102 determines the criticality of the task by predicting the prior experience of the user with the task, assigning a skill score to the prior experience of the user, and determining that the skill score is below a skill threshold. In some embodiments, the gamification device 102 determines a number of times the user experiences the task simulation in the virtual reality simulation based on the skill score of the task for the user or the criticality score for the task. In some embodiments, the gamification device 102 determines a state level of the user while the user is utilizing the task simulation and determines a number of times the user experiences the task simulation based on the state level.

In some embodiments, the gamification device 102 prompts the user to utilize the task simulation after assessing the timeframe for the user to perform the task in the contextual situation. In some embodiments, the gamification device 102 prioritizes generating a first task simulation in the argument reality simulation over generating a second task simulation.

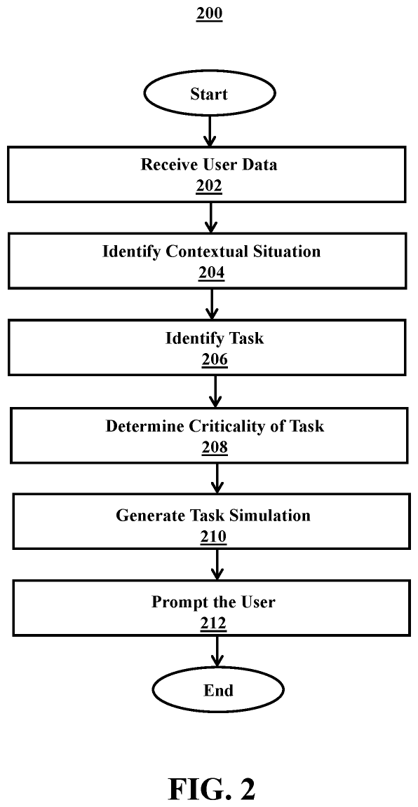

Referring now to FIG. 2, illustrated is a flowchart of an exemplary method 200 for simulating tasks likely to be encountered in a contextual situation, in accordance with embodiments of the present disclosure. In some embodiments, a processor of a system may perform the operations of the method 200. In some embodiments, method 200 begins at operation 202. At operation 202, the processor receives user data associated with a user. In some embodiments, the user data includes data associated with a prior experience of the user. In some embodiments, method 200 proceeds to operation 204, where the processor identifies, using an artificial intelligence model, a contextual situation the user is likely to encounter in the future. In some embodiments, method 200 proceeds to operation 206. At operation 206, the processor identifies, using the artificial intelligence model, a task that the user is likely to perform in the contextual situation. In some embodiments, method 200 proceeds to operation 208. At operation 208, the processor determines, using the artificial intelligence model, a criticality of the task the user is likely to perform in the contextual situation. In some embodiments, method 200 proceeds to operation 210. At operation 210, the processor generates a simulation of the task in a virtual reality simulation. In some embodiments, method 200 proceeds to operation 212. At operation 212, the processor prompts the user to utilize the task simulation to learn how to perform the task.

As discussed in more detail herein, it is contemplated that some or all of the operations of the method 200 may be performed in alternative orders or may not be performed at all; furthermore, multiple operations may occur at the same time or as an internal part of a larger process.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

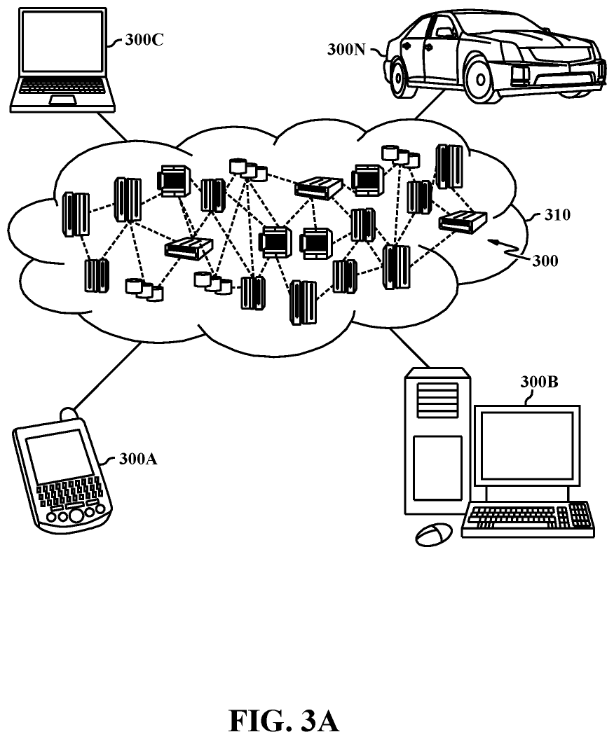

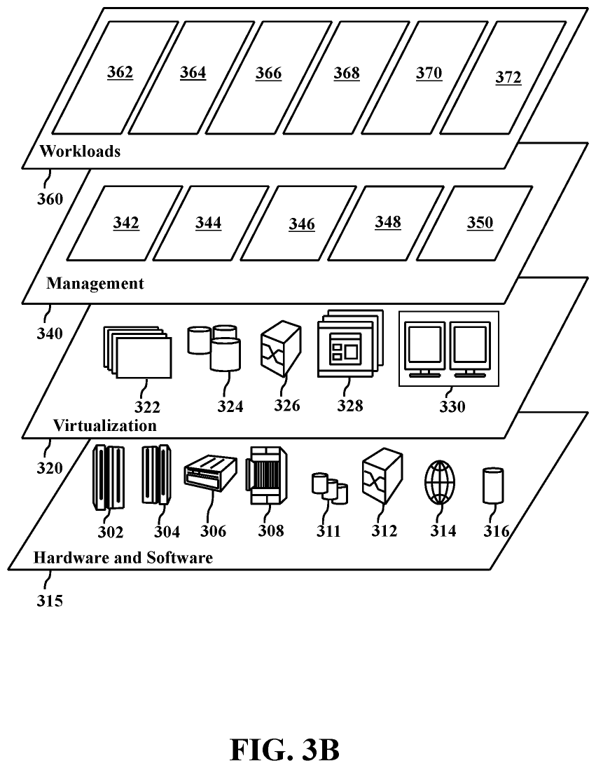

FIG. 3A, illustrated is a cloud computing environment 310 is depicted. As shown, cloud computing environment 310 includes one or more cloud computing nodes 300 with which local computing devices used by cloud consumers, such as, for example, personal digital assistant (PDA) or cellular telephone 300A, desktop computer 300B, laptop computer 300C, and/or automobile computer system 300N may communicate. Nodes 300 may communicate with one another. They may be grouped (not shown) physically or virtually, in one or more networks, such as Private, Community, Public, or Hybrid clouds as described hereinabove, or a combination thereof.

This allows cloud computing environment 310 to offer infrastructure, platforms and/or software as services for which a cloud consumer does not need to maintain resources on a local computing device. It is understood that the types of computing devices 300A-N shown in FIG. 3A are intended to be illustrative only and that computing nodes 300 and cloud computing environment 310 can communicate with any type of computerized device over any type of network and/or network addressable connection (e.g., using a web browser).

FIG. 3B, illustrated is a set of functional abstraction layers provided by cloud computing environment 310 (FIG. 3A) is shown. It should be understood in advance that the components, layers, and functions shown in FIG. 3B are intended to be illustrative only and embodiments of the disclosure are not limited thereto. As depicted below, the following layers and corresponding functions are provided.

Hardware and software layer 315 includes hardware and software components. Examples of hardware components include: mainframes 302; RISC (Reduced Instruction Set Computer) architecture based servers 304; servers 306; blade servers 308; storage devices 311; and networks and networking components 312. In some embodiments, software components include network application server software 314 and database software 316.

Virtualization layer 320 provides an abstraction layer from which the following examples of virtual entities may be provided: virtual servers 322; virtual storage 324; virtual networks 326, including virtual private networks; virtual applications and operating systems 328; and virtual clients 330.

In one example, management layer 340 may provide the functions described below. Resource provisioning 342 provides dynamic procurement of computing resources and other resources that are utilized to perform tasks within the cloud computing environment. Metering and Pricing 344 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 346 provides access to the cloud computing environment for consumers and system administrators. Service level management 348 provides cloud computing resource allocation and management such that required service levels are met. Service Level Agreement (SLA) planning and fulfillment 350 provide pre-arrangement for, and procurement of, cloud computing resources for which a future requirement is anticipated in accordance with an SLA.

Workloads layer 360 provides examples of functionality for which the cloud computing environment may be utilized. Examples of workloads and functions which may be provided from this layer include: mapping and navigation 362; software development and lifecycle management 364; virtual classroom education delivery 366; data analytics processing 368; transaction processing 370; and simulating tasks likely to be encountered in a contextual situation 372.

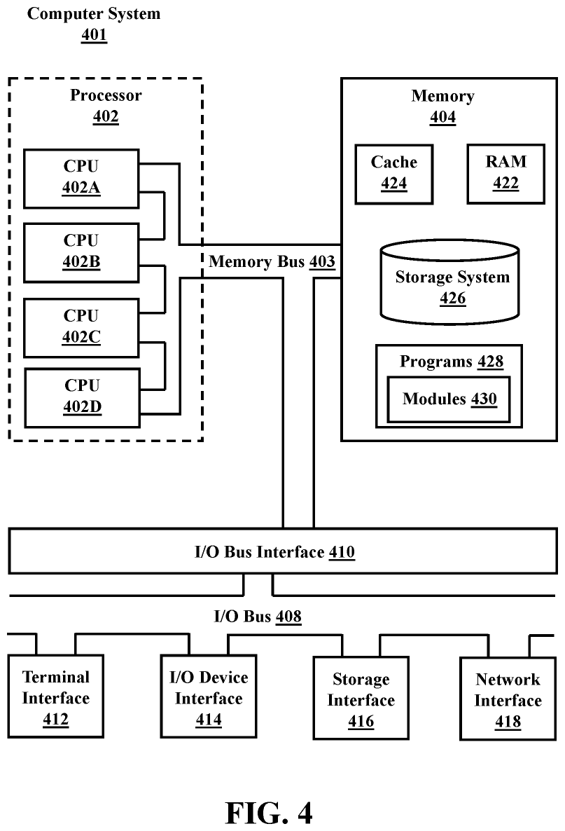

FIG. 4, illustrated is a high-level block diagram of an example computer system 401 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 401 may comprise one or more CPUs 402, a memory subsystem 404, a terminal interface 412, a storage interface 416, an I/O (Input/Output) device interface 414, and a network interface 418, all of which may be communicatively coupled, directly or indirectly, for inter-component communication via a memory bus 403, an I/O bus 408, and an I/O bus interface unit 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may include one or more levels of on-board cache.

System memory 404 may include computer system readable media in the form of volatile memory, such as random access memory (RAM) 422 or cache memory 424. Computer system 401 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

One or more programs/utilities 428, each having at least one set of program modules 430 may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

Although the memory bus 403 is shown in FIG. 4 as a single bus structure providing a direct communication path among the CPUs 402, the memory subsystem 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 401 may, in some embodiments, contain multiple I/O bus interface units 410, multiple I/O buses 408, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface, but receives requests from other computer systems (clients). Further, in some embodiments, the computer system 401 may be implemented as a desktop computer, portable computer, laptop or notebook computer, tablet computer, pocket computer, telephone, smartphone, network switches or routers, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A computer-implemented method, the method comprising:
receiving, by a processor, user data associated with a user, wherein the user data includes data associated with a prior experience of the user;
identifying, using an artificial intelligence model, a contextual situation the user is likely to encounter;
identifying, using the artificial intelligence model, a task that the user is likely to perform in the contextual situation;
determining, using the artificial intelligence model, a criticality of the task the user is likely to perform in the contextual situation;
generating a simulation of the task in a virtual reality simulation; and
prompting the user to utilize the task simulation to learn how to perform the task.

2. The method of claim 1, wherein prompting the user to utilize the task simulation includes an assessment of a timeframe for the user to perform the task in the contextual situation.

3. The method of claim 1, wherein determining the criticality of the task includes:
determining a criticality score for the task; and
determining that the criticality score exceeds a criticality threshold.

4. The method of claim 1, wherein determining the criticality of the task includes:
predicting the prior experience of the user with the task;
assigning a skill score to the prior experience of the user; and
determining that the skill score is below a skill threshold.

5. The method of claim 4, further comprising:
determining a number of times the user experiences the task simulation in the virtual reality simulation based on the skill score of the task for the user or the criticality score for the task.

6. The method of claim 4, further comprising:
identifying a timeframe for the user to perform a first task;
identifying a second timeframe for the user to perform a second task;
comparing the first timeframe to the second timeframe; and
prioritizing a generation of a first task simulation in the virtual reality simulation.

7. The method of claim 1, further comprising:
determining a state level of the user while the user is utilizing the task simulation; and
determining a number of times the user experiences the task simulation in the virtual reality simulation based on the state level.

8. A system comprising:
a memory; and
a processor in communication with the memory, the processor being configured to perform operations comprising:
receiving user data associated with a user, wherein the user data includes data associated with a prior experience of the user;
identifying, using an artificial intelligence model, a contextual situation the user is likely to encounter;
identifying, using the artificial intelligence model, a task that the user is likely to perform in the contextual situation;
determining, using the artificial intelligence model, a criticality of the task the user is likely to perform in the contextual situation;
generating a simulation of the task in a virtual reality simulation; and
prompting the user to utilize the task simulation to learn how to perform the task.

9. The system of claim 8, wherein prompting the user to utilize the task simulation includes an assessment of a timeframe for the user to perform the task in the contextual situation.

10. The system of claim 8, wherein determining the criticality of the task includes:
determining a criticality score for the task; and
determining that the criticality score exceeds a criticality threshold.

11. The system of claim 8, wherein determining the criticality of the task includes:
predicting the prior experience of the user with the task;
assigning a skill score to the prior experience of the user; and
determining that the skill score is below a skill threshold.

12. The system of claim 11, the processor being further configured to perform operations comprising:
determining a number of times the user experiences the task simulation in the virtual reality simulation based on the skill score of the task for the user or the criticality score for the task.

13. The system of claim 11, the processor being further configured to perform operations comprising:
identifying a timeframe for the user to perform a first task;
identifying a second timeframe for the user to perform a second task;
comparing the first timeframe to the second timeframe; and
prioritizing a generation of a first task simulation in the virtual reality simulation.

14. The system of claim 8, the processor being further configured to perform operations comprising:
determining a state level of the user while the user is utilizing the task simulation; and
determining a number of times the user experiences the task simulation in the virtual reality simulation based on the state level.

15. A computer program product comprising a computer readable storage medium having program instructions embodied therewith, the program instructions executable by a processor to cause the processor to perform operations, the operations comprising:
receiving user data associated with a user, wherein the user data includes data associated with a prior experience of the user;
identifying, using an artificial intelligence model, a contextual situation the user is likely to encounter;
identifying, using the artificial intelligence model, a task that the user is likely to perform in the contextual situation;
determining, using the artificial intelligence model, a criticality of the task the user is likely to perform in the contextual situation;
generating a simulation of the task in a virtual reality simulation; and
prompting the user to utilize the task simulation to learn how to perform the task.

16. The computer program product of claim 15, wherein prompting the user to utilize the task simulation includes an assessment of a timeframe for the user to perform the task in the contextual situation.

17. The computer program product of claim 15, wherein determining the criticality of the task includes:
determining a criticality score for the task; and
determining that the criticality score exceeds a criticality threshold.

18. The computer program product of claim 15, wherein determining the criticality of the task includes:
predicting the prior experience of the user with the task;
assigning a skill score to the prior experience of the user; and
determining that the skill score is below a skill threshold.

19. The computer program product of claim 18, the processor being further configured to perform operations comprising:
determining a number of times the user experiences the task simulation in the virtual reality simulation based on the skill score of the task for the user or the criticality score for the task.

20. The computer program product of claim 18, the processor being further configured to perform operations comprising:
identifying a timeframe for the user to perform a first task;
identifying a second timeframe for the user to perform a second task;
comparing the first timeframe to the second timeframe; and
prioritizing a generation of a first task simulation in the virtual reality simulation.
